(19) United States
(12) Patent Application Publication
(10) Pub. No.: US 2007/0104842 A1
(43) Pub. Date: May 10, 2007

(54) Method and apparatus for removal of grape seeds from grape skin

(75) Inventors: Geoffrey Margolis, Los Angeles, CA (US); Ernest J. Gallo, Modesto, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: E. & J. GALLO WINERY, Modesto, CA (US)

(21) Appl. No.: 11/590,155

(22) Filed: Oct. 31, 2006

Related U.S. Application Data
(60) Provisional application No. 60/731,953, filed on Oct. 31, 2005.

(51) Int. Cl. A23L 1/36

(52) U.S. Cl. 426/484

(57) ABSTRACT

The invention provides a method and apparatus for separating grape seeds from the pulp and skin of a grape comprising depositing grapes on a plate having apertures there-through and driving the grapes across the plate by means of a blade such that the grape seeds and juice will pass through the apertures of the plate while retaining grape skin. The grape juice may then be separated from the seeds and recombined with the pulp and skin for fermentation to produce a wine having an improved flavor profiles as a result of the different tannin contents of skin and seeds. Also provided is a method and apparatus for opening grape berries without fracturing their grape seeds.

This application claims benefit of U.S. Provisional Application Ser. No. 60/731,953 filed Oct. 31, 2005.

### BACKGROUND OF THE INVENTION

The present invention relates to methods and apparatus for separating grape seeds from the skins, pulp and juice of grapes. In addition, the invention is directed to methods of producing wines with improved taste profiles by fermenting grape must comprising juice, pulp and skins, either in the absence or in the presence of grape seeds.

It is well known that red wines are made by fermenting grape juice in the presence of more or less crushed red grapes including the berry's skins, pulp and seeds. White wines are typically produced by the fermentation of juice in the absence of both skins and seeds. Nevertheless, some white wines include a partial contact and/or fermentation with white grape berries.

During fermentation of red grape must, various techniques are used to contact the grape juice with the skins and seeds. These procedures enhance the color and modify the taste of the ultimate wine being produced.

The color of red wine is derived from anthocyanin compounds extracted solely from the skins of red grapes during fermentation.

In addition, both the skins and seeds are also rich sources of polyphenolic compounds, collectively called tannins, which are similarly extracted, particularly during red grape fermentation. In contrast, white wines fermented in the absence of skins and seeds usually lack both skin and seed tannins.

Whereas it is recognized that these tannin compounds can enhance some positive taste qualities of wine (such as “body” and “mouth feel”), they are major contributors to “astringency” and “bitterness”—some of which produce undesirable qualities in wine.

Much attention has been given in the winemaking art to the impact on wine taste resulting from astringency and bitterness of tannins and particularly condensed or polymeric tannins in grapes. Gawel, Aust. J. of Grape & Wine Res. 4, 74 (1998) reviews the astringency of red wines as well as the differences between grape seed and grape skin proanthocyanidin (tannins). Similarly Arnold Am. J. Enol. Vit. 29, 150 (1978) and Brossaud et al. Aust. J. of Grape & Wine Res. 7, 33 (2001) have studied the bitterness and astringency of grape seed phenolics.

Kantz and Singleton, Am. J. Enol. Vit. 41, 223 (1990) showed that approximately 65% of the total phenolic compounds (the majority of which are tannins) in grape berries are located in the grape seeds. The remaining phenols are largely located in the grape skin.

Peyrot des Gachon and Kennedy, J. Agric. Food Chem. 51, 5877 (2003) developed a method for determining the amounts of seed and skin tannins extracted into wines during grape fermentation. Their data showed that approximately 50% of the tannins actually present in wine were indeed derived from the seeds present during fermentation.

Furthermore, Peyrot des Gachon and Kennedy (2003) clearly demonstrated analytically that the chemical composition of tannins extracted from seeds into wine were different from the chemical composition of tannins extracted from skins into wine. In particular, they showed that the breakdown products of acid catalyzed cleavage of seed tannins contained no epigallocatechin: This is in contrast to the breakdown products of skin tannins which did in fact contain epigallocatechin. Similarly, their data showed that the breakdown products of seed tannins contained significantly more (by a factor of approximately 4) epicatechin-3-O-gallate than the breakdown products of skin tannins. This analytical procedure was also used by Peyrot des Gachon and Kennedy (2003) to determine the source of tannins (i.e. did they come from seeds or skins) that are present in wine.

The tannic compounds in seeds and skins are of varying molecular weights and composition. Whereas the molecular weight of the tannic compounds in seeds and skins are partially dependent on variety and the degree of ripeness of the berry, it has been shown that higher molecular weight (i.e., polymeric) tannins typically associated with skins increase “astringency” in wines. Lea & Arnold, J. Sci. Food Agric. 29, 478 (1978) and Porter et al., Phytochemistry 23, 1255 (1984)). On the other hand, lower molecular weight tannins typically associated with skins increase “bitterness” in wines. Moreover, higher molecular weight tannins, and particularly those from seeds, tend to be more soluble in alcohol solutions than in pure aqueous solutions with increasing quantities of tannins being extracted during longer and warmer fermentations (Singleton & Draper Am. J. Enol. Vit. 15, 34 (1964)).

Thus there is significant interest in developing improved methods to remove seeds from grape must prior to fermentation (to minimize any lengthy alcoholic extraction of tannins) in order to substantially improve wine quality. In addition, it would be desirable to separate grape seeds from the pulp, juice and skins of grapes in a manner which avoids the splitting or fragmentation of the seeds which in itself can release less desirable seed tannins and other undesirable components into the fermenting grape must.

Grapes comprise the following components by weight (wet): skins 15-20%; seeds 3-6%; juice/mucilage (pulp) 74-90% (Boulton et al. “Principles and Practice of Wine Making” p. 40). Grape seeds are generally pear shaped with dimensions ranging from 3/32 to 3/16 inch (dependant on maturity and variety). Grapes contain from one to four seeds each; and roughly one ton of grapes (representing the minimum quantity frequently fermented industrially) would typically contain approximately 1 million seeds.

There exist various methods for the separation of seeds from other portions of grapes and other fruits but many such methods are impractical on a large scale. For example, a single acre of vineyard typically yields 5 tons of grapes sufficient to produce about 4500 bottles (750 ml) of wine. The grapes from this acre contain as many as 5,000,000 grape seeds. In the year 2000, Sonoma County in California, USA alone had 55,000 acres of grape vineyards which together would have produced an astounding 275 billion grape seeds! While there are many methodologies for small scale separation of seeds the scale of commercial wine production demands that improved methods for the separation of the skins from the seeds of grapes be developed. While it is relatively easy to remove the solids portions (seeds and skins) from the liquid portions (pulp and juice) of a grape, it is much more difficult to separate the solids portions from each other. In particular this is more difficult in the context of a grape which has been crushed to remove its juice according to conventional wine processing.

A crushed grape typically comprises a sac of skin surrounding gelatinous mucilage having the grape seeds disposed therein. Because of the viscous, adherent nature of such crushed grapes it is quite difficult to separate the seeds from within this sandwich. In particular, it is difficult to separate the seeds from the skins without fragmenting the seeds which can result in the release of tannins into the surrounding materials. Moreover, the small size of grape seeds and the viscous nature of the other grape components make it difficult to readily separate the seeds by traditional straining methods which retain the seeds while passing the liquid and other solid materials through a sieve.

In traditional winemaking, grapes are first destemmed and crushed prior to fermentation. Conventional destemmer/crushers typically use rollers which are separated by an adjustable gap. These devices are designed to open a very high percentage of the grapes that pass between the rollers. These devices can, however, crush the seeds as well, which releases the undesirable tannins into the grape juice. In order to avoid this, some vintners have adjusted the rollers to create a larger gap between them. While this reduces the numbers of seeds that are crushed, it also allows 30-50% of the grapes to pass through the device in an unopened state, thereby diminishing the amount of juice extracted from the grapes.

While there exist methods for improving the extraction of juice without damaging the seeds such methods have their own limitations and drawbacks. Thermoflashing methods which use heat in conjunction with vacuum to “explode” grape berries suffer from the disadvantage that the application of heat accelerates the perfusion of undesirable chemical species from the seeds into the juice. The heat also changes the nature of some of the delicate flavor providing compounds. Finally, thermoflashing is very energy intensive and relatively expensive as a result.

Alternative methods for opening the grape berries such as cryoflashing avoid the undesirable effects of heating but are also impractical because of their high energy consumption. Accordingly, there is a need for a device that will open a very high percentage of the grapes without damaging the seeds or otherwise extracting undesirable components from the seeds or forming undesirable compounds.

By way of reference, typical industrial destemmer/crushers operate by continuously feeding a defined quantity of grapes at rates of up to 4 tons of grapes per minute. (Note that 1 ton of grapes represents approximately 30 ft³ of skins/seeds juice and pulp. Of this, the skins and seeds represent approximately ⅓ of this volume, i.e., 10 ft³.)

Of interest to the present invention is the disclosure of Sitton et al., ASEV 52nd Annual Meeting, San Diego, Calif. June 2001 directed to the roles of grape skins and seeds in phenolic extraction during fermentation and extended maceration of wine. Experiments were conducted measuring the differences between a Cabernet Sauvignon wine produced by means of an early press with no skins or seeds; an early press in which the seeds were separated and returned to the juice, an early press with the skins separated and returned to the juice and a normal extended maceration.

By way of background and of interest to the present invention various disclosures regarding separation of seeds from the fruits of grapes and other fruits are set out below.

Malan et al., Am. J. Enol. Vitic., Vol. 29, No. 2, 125 (1978) discloses a pin-mill crusher designed to strip the adhering flesh from skins and seeds without damaging the seeds.

A device manufactured by FABBRI is disclosed that processes grapes involving a step in which rapid heating is followed by rapid cooling and expansion of the grapes in a vacuum in order to make the skin cell walls more fragile allowing a quicker and more thorough diffusion of tannins (i.e., “thermoflashing”).

Ventner et al. U.S. Pat. No. 3,826,849 disclose a method by which grape skins are separated from pips (seeds) in the freshly crushed state by hand separation through holed screens. The patent discloses a wine making process in which the grape berries are crushed, the skins and pips are first partially fermented, the skins and pips are separated from the pulp and then from each other. The skins are then finely comminuted and added back to the partially fermented pulp and the suspension of partially fermented pulp and comminuted skins is fermented to make wine.

Eymeric U.S. Pat. No. 2,500,981 discloses a device comprising a rotary drum with a perforate cylinder wherein the softer materials are issued radially through the openings in the cylinder and the harder materials such as the seeds are retained by the openings of the cylinder and discharged axially out the top of the cylinder.

Derbenwick et al., U.S. Pat. No. 2,516,963 disclose a centrifugal pitter for fruit wherein the pulp of the fruit is spun outward by centrifugal force and passes through rods which retain the seeds or pits of the fruit.

Kondos et al., U.S. Pat. No. 3,971,310 discloses a press for squeezing grapes utilizing a pair of perforated belts. Helwig, U.S. Pat. No. 4,132,161 discloses a device for separating the liquid part from the solid part of seeds and fruit wherein the raw material is subjected to pressure within a vessel which is then released rupturing the cells of the material.

van Olphen, U.S. Pat. No. 4,177,722 discloses an apparatus for the continuous separation of grape pulp and juice from the seeds (pits) and skins of grapes. The apparatus comprises a rotor and a screen which are rotatably mounted and are rotated at circumferential speeds differing by at least 10%. The device retains the seeds and skins of the grapes on the screen while pulp, flesh and juice of the grapes pass through.

Miller, U.S. Pat. No. 4,233,157 discloses a traveling sheet, flat bed filter apparatus wherein a fluid is delivered across a traveling filter paper. Hunt, et al., U.S. Pat. No. 4,266,473 discloses a screw press for extraction of juice from grapes whereby juice passes through slotted screens which retain grape seeds and other solids.

Hunt et al., U.S. Pat. No. 4,323,007 disclose a method for extraction of juice from fruit using a screw press wherein the fruit is gently compressed as it passes through the screw press and the juice is separated from the remaining solids which are recycled to the input for additional compressing.

Spinato, U.S. Pat. No. 4,457,223 discloses a grape crusher and de-stemmer comprising a perforated drum having a spiral rotor blade which splits the berries to release their juice. Steinke, U.S. Pat. No. 4,587,896 discloses an apparatus for collecting different grades of juice using a screw press wherein different grades of juice are separated at different points along the screw press.

Schulman, U.S. Pat. No. 4,609,110 discloses a seed separating method and apparatus wherein a conveyor belt carrying grapes passes beneath a roller arm that extends across the conveyor belt forming a narrow gap between the roller arm and the belt. The skin and pulp of the grapes can pass through the gap, while the seeds cannot. Instead, the seeds slide down the longitudinal axis of the roller arm and fall off the belt into a collector receptacle.

European Patent No. 522,238 discloses a device which separates the seeds of grapes from the pulp and juice by utilizing a plurality of roller arms. The roller arms are separated by a narrow gap through which the juice, skin and pulp may pass, but through which the seeds do not. At least one roller arm includes a rib extending out from the roller arm. The seeds are transported down the length of the shafts along the ribs of the shaft and then are collected in a separate hopper.

Powers et al., U.S. Pat. No. 4,889,739 disclose a method for producing orange juice with a “hand-squeezed” character wherein pulp is isolated from the orange fruit.

Maisonneuve, U.S. Pat. No. 5,012,731 discloses a method whereby heterogeneous solutions such as grapes are pressed along with their seeds and skins by a central shaft with vanes against a conical member inside a cylindrical drum having perforated walls through which the juice is allowed to escape.

Rabinovich et al., U.S. Pat. No. 5,918,819 disclose a device for isolating the seeds from their mucous coats.

Despite the many methodologies described in the art there remains a need for improved methods of separating seeds from skins and the other components of grapes.

### SUMMARY OF THE INVENTION

The present invention is directed to methods for separating the seeds from the skin, pulp and juice of a grape and relates to the discovery that grape seeds may be readily separated from grape skins wherein the grape seeds are passed through apertures of a size nominally sufficient to also have grape skins pass there-through. Specifically, the invention provides a method wherein grapes are driven across an apertured plate by means of a blade and the seeds and juice are passed through an apertured plate while the grape skin and grape pulp are retained on the plate prior to collection. As used herein unless otherwise noted, “juice” refers to both juice derived from grape berries and the mixture of water and juice derived from grape berries in any combination.

The method successfully separates grape seeds from skins at a high rate of throughput and avoids the splitting or crushing of seeds which can release undesirable tannins into the grape must. The methods and devices of the invention utilize a unique orientation of an apertured plate and a blade driving grapes and grape components across the plate to separate grapes seeds from other solids such as skin. The inventive method is surprisingly effective in separating grape seeds from the skins despite the fact that the apertures in the plate are of dimensions larger than that of grape skins.

More specifically, the invention provides a method for separating grape seeds from the skin of a grape comprising the steps of: introducing grape must onto the first side of a plate having first and second sides and apertures there-through of a size and shape selected such that grape seeds, juice and skin can nominally pass through to the second side of the plate. (As used herein unless otherwise noted “grape must” refers to both intact and crushed grapes and mixtures thereof and mixtures of components thereof.) The grape must is then driven across the plate by means of a grape driving blade having a grape contacting face disposed such that the clearance between the blade and the plate is most preferably less than the diameter of a grape seed in order that grape seeds will not be bypassed by the blade. The motion of the blade applies force parallel to the surface of the plate and drives the grapes across the surface of the plate but also applies force normal to the plane of the plate such that the grape seeds and juice will pass through the apertures of the plate while retaining grape skin on the first side of the plate. The method may be applied to grape must for the production of wine but can also be applied to grape pomace (also called “marc”) for the separation of grape seeds which can then be used for extraction of tannins and other valuable compounds.

While the apertures are of a size where they are nominally capable of having grape skins pass there-through, the size of the apertures and the orientation of the grape driving blade is such that grape skins typically pass over the apertures and are not driven through the apertures. This is in contrast to the seeds which are capable of being “caught” by the edges of the apertures and are then driven downward through the plate to its second side by the force component of the grape driving blade.

It is preferred that all or substantially all of the grape skins be retained on the first side of the plate and it is usually so retained according to ordinary practice of the invention. The grape seeds and juice are then collected from the second side of the plate and may be further separated from each other by conventional means such as by passing through a sieve, by floatation, centrifugation or other means. The seed-free grape juice may then be recombined with grape skins and pulp collected from the first side of the plate and may be subjected to fermentation steps or other treatment. The seed-free grape juice may also be recycled back to the first side of the plate and used as a transporting fluid to hydrate the grape must and assist in its flowability. Alternatively, juice or other transporting fluid need not be recycled to the first side of the plate but an excess of transporting fluid such as water can be introduced to the first side of the plate and then removed downstream of the seed/skin separation by methods such as membrane separation or thin film evaporation. It is further contemplated that the grape juice, pulp, skins and seeds may be recombined in any combination or not at all or that they can be recombined in various combinations with juice, pulp, skins and/or seeds derived from different varieties or different harvests.

The apertured plate may be flat or can be curved or undulating. According to one preferred aspect of the invention, the plates are curved and undulating above and below the horizontal plane with some portions of the plate lying below the surface of a reservoir containing grape juice and some portions lying above. In this manner the grape driving blade can drive grape must along the plate but below the surface of grape juice so as to introduce moisture to the grape must being treated to assist in subsequent seed/skin separation. As the apertured plate undulates to a higher level the plate is above the surface of the grape juice and the grape must becomes drier.

Also provided is an apparatus for separating grape seeds from the pulp and skin of a grape comprising a plate having a first side and a second side and apertures there-through selected such that grape seeds, juice and skin can nominally pass through to the second side of the plate. The apparatus also comprises a grape driving blade having a grape contacting face disposed adjacent the plate with the clearance between the blade and the plate being less than the diameter of a grape seed. In this manner grape seeds are not able to pass under the blade as it drives grape material across the plate. The blade is further disposed such that when it moves parallel to the plane of the plate it applies forces to the grapes which are both parallel to and normal to the plane of the plate such that the grape seeds and juice will pass through the apertures of the plate while retaining grape skin. Mechanical means are also provided for driving the blade in a direction parallel to the plate to move grapes across the plate. As would be readily recognized by those of skill in the art, the important aspect of the invention is the relative motion of the plate and the blade. Accordingly, reference to driving the blade across the plate also contemplates the embodiment in which the blade is stationary and the plate is in motion.

The apparatus also comprises means such as chutes for depositing grape must onto the first side of the plate as well as means such as chutes or channels for collecting grape seeds and juice which pass through the apertures of the plate. The apparatus also includes means for collecting grape skins and pulp which are retained on the first side of the plate. According to one aspect of the invention, grape skins and pulp may be collected by a trough disposed at the end of the plate into which the skins and pulp are pushed by the blade. The invention also provides means such as sieves or other separation apparatus for separating grape seeds from the juice which have passed through the apertures of the plate.

Those of ordinary skill would recognize that the methods of the present invention can be practiced in a variety of different manners with differently constructed devices. Thus, according to one aspect of the invention, a series of trapezoidal apertured plates are arranged around a central axis and one or more grape driving blades rotate around the series of trapezoids driving grape must along apertured plates. According to an alternative construction, the apertured plate is rectangular and elongated and the grape driving blade is mounted on a conveyor which drives the blade across the length of the plate. Multiple blades can be mounted on a continuous conveyor. It has been found that the apertured plate need not be flat but rather can curve up or down or be undulating. Thus, an undulating apertured plate can be disposed such that its lower portions lie below the surface of a trough filled with grape juice or other transporting fluid such as water in order that the grape must is rewetted as it is propelled by the driving blades. Still other embodiments of the invention are provided in which the apertured plate takes an arcuate shape and the separating blades are disposed on a rotating circular support, preferably a cylindrical drum, coaxial with the arc defined by the apertured plate.

According to a further aspect of the invention, it has been discovered that the methods and apparatus for separating grape seeds from grape skin function in an improved fashion when a high proportion of grape berries present in the grape must have been opened (i.e., have a ruptured skin so as to expose the pulp and seeds therein) to expose the seeds prior to being driven across the apertured plate. Specifically, it is the case that conventional destemming/crushing methodologies are not always practiced in a manner so as to open grape berries to expose a significant fraction of the grape berries.

The invention provides methods and devices for opening grape berries in a manner in which few or essentially no seeds are fractured. It has been found that placing grape must diluted with grape juice in a variable speed laboratory blender, operating between 5,000 and 10,000 rpm opens the grape berries and exposes all the seeds such that they can be readily separated from the skins and pulp by the methods of the first aspect of the present invention. Surprisingly, the inventive method is able to expose the seeds in a manner that causes minimal damage to the seeds and skins. In particular, it is preferred that the grape seeds not be fractured in order to prevent release of tannins. It is also preferred that the grape skins not be so shredded that they later clog the apertures of the seed/skin separating plates of the invention. It has been found that this method ruptures the grape berries and exposes seeds in a manner which avoids shredding the skins and produces a must which is substantially free of fractured seeds. Without intending to be bound by any particular theory of the invention it is believed that the structure of a grape berry comprising skin, mucilage and seeds is such that the blades are only capable of breaking the skin and mucilage but not fracturing seeds when appropriate residence times and blade speeds are selected. Such residence times and blade speeds may vary according to the variety of grape being processed but can be readily determined empirically by those of ordinary skill.

While this aspect of the invention can be used in the production of white wine as a method of opening the grapes before optionally sending them to the press it may be most valuable in the production of red wines. Accordingly to such methods the red wine grapes are opened using the device and the grape must comprising juice, pulp, seeds and skin may be introduced into a fermenter to produce wine. Alternatively, the must comprising opened berries and unfractured seeds can be processed in accordance with the invention in order to separate the seeds and juice from the skins and pulp. The juice can then be recombined with the skins and pulp and fermented in the absence of seeds to produce wine. The resulting red wine has a novel flavor profile because of the presence of relatively fewer seed derived tannins. In addition, the method preserves the commercial value of the separated seeds from which tannins can later be extracted to serve as dietary supplements. This is because seeds which have been subjected to a conventional fermentation lose some of the tannins desired for use in dietary supplements. In addition, seeds which have been dried as part of conventional methodologies for separating seeds from skins are more resistant to extraction of tannins, regardless of whether such tannins have previously been extracted.

In order to further process this rich slurry, it is preferred to thin out the rich slurry by increasing its liquid to solid ratio. According to one method, a fraction of previously separated grape juice may be recycled back to the incoming crushed grapes to further thin the slurry.

Specifically, the invention provides a method of opening grape berries comprising the steps of combining grape berries with transporting fluid, which is preferably grape juice, introducing grape berries into an apparatus comprising a container and a means for generating shear; and applying a shear force sufficient to break open the skin of grape berries within said container to produce a mass comprising grape pulp, seeds and skin wherein a majority of the berries are opened and relatively few of the seeds are fractured. By “fractured” is meant a chip or break in the whole of a seed or other fragmentation such as allows more ready release of tannins and other chemical constituents of the seed. According to preferred methods greater than 70%, 80%, 90% or 95% of the berries are opened while fewer than 10%, 5%, 2% or 1%, of the seeds are fractured.

The devices of the invention can use different means for generating shear but a preferred means is the use of a blade mounted for axial rotation within a container. The blade preferably comprises at least two flat blades which extend radially outwardly from the blade's axis of rotation and more preferably includes more than one set of blades mounted on a common axis.

According to one aspect of the invention, the blade speed should be carefully selected to provide a level of shear sufficient to open the grape berry and expose the seeds but not so high as to impact and fracture the seeds. While blade speeds in the range from 5,000 rpm to 10,000 rpm have been found to be useful in producing sufficient shear to open the berries without fracturing seeds in a batch-style device such as a conventional blender, blade speeds of from 1500 to 6000 rpm and even more preferably 1500 to 3600 rpm have been found to be particularly useful in the continuous process device of the invention such as wherein grape berries and a transporting fluid such as juice are pumped into an elongated tube comprising the axially rotating blades. According to one aspect of the invention, a rotor speed of about 2000 rpm in such a continuous processing device is particularly preferred. Nevertheless, those of skill in the art would be capable of empirically determining suitable blade speeds for differently configured and sized blades to produce appropriate shear levels.

In order to prevent increased oxidation of the must which might occur after to the opening of the berries, it is contemplated that the amount of oxygen (O₂) introduced into the must can be reduced by a number of methods including, but not limited to operating under an anaerobic atmosphere or saturating the incoming liquid with CO₂, nitrogen or other gas to reduce such oxidation.

The devices of the invention may be operated on a batch basis but are preferably operated on a continuous basis wherein grape berries are constantly introduced to and grape pulp, seeds, skin and juice are removed from the apparatus on a continuous basis.

A preferred apparatus of the invention comprises a container such as an elongated tube in which grape berries are introduced at a first end and grape pulp, seeds and skin are expelled at a second end. According to a preferred aspect of the invention, a shaft having several blades protruding there from is positioned on the center axis of the elongated tube.

Because of the high solids level and viscosity of grape must, it is preferred that the grape must be diluted with a transporting fluid, which can be water or another aqueous substance but is preferably grape juice. Grape juice can then be separated from the grape must product of the apparatus and then recycled to be combined with grape must being introduced to the device of the invention. Grape juice is preferably recombined with grape must such that the ratio of juice introduced to the apparatus to grape solids introduced to the apparatus is preferably above 0.5 to 1 with a ratio of from 3 to 1 to 0.5 to 1 being more preferred and a ratio of 1 to 1 being most preferred. Alternatively, the transporting fluid or juice need not be recombined or recycled. Instead, high levels of transporting fluid, such as water, can be combined with the grape must to aid the separation of seeds from the grape skins and pulp, and such transporting fluid can be removed from the product stream by conventional means such as membrane separators or thin film evaporators.

The grape must having a high proportion of open berries can then be treated in accordance with other aspects of the invention to separate grape seeds and skins.

While the above-described method has particular utility when practicing those aspects of the invention wherein the seeds are separated from the grape skins, juice and pulp, the method and apparatus may also be used to produce grape must for carrying out a conventional fermentation. In this manner, the yield of juice obtained from grape berries is increased in a manner which does not otherwise crush grape seeds or extract undesirable components from such seeds or produce other undesirable components. Practice of such a methodology results in improved juice yields while avoiding the disadvantages including increased expenses and negative effects on wine quality usually associated with other methods of improving such yields. Specifically, a method of producing wine is provided comprising the steps of combining grape berries and a transporting fluid such as grape juice or water in an apparatus comprising a container and a means for generating shear; and applying a shear force sufficient to break open the skin of grape berries within the container to produce a mass comprising grape pulp, seeds, skin and grape juice wherein greater than 70% of said berries are opened and wherein fewer than 5% of the seeds are fractured and fermenting the mass to produce wine.

The apparatus and methods of the invention make possible the practice of methods for producing improved wines, particularly red wine, which have improved and sometimes novel taste profiles as a result of the different tannin contents. These differences include but are not limited to differences in chain lengths and molecular weights of the tannins as well as differences in epicatechin-3-O-gallate and epigallocatechin contents of skin and seeds. Thus, it is generally contemplated by the invention to reduce the content of less desired seed derived tannins relative to the presence of more desired skin derived tannins. Specifically, the invention contemplates the fermentation of grape must comprising grape juice, pulp and skins but which is largely free of grape seeds. By fermenting the grape must in the absence of grape seeds a wine is produced which is characterized by a tannin composition which differs from that produced when grape seeds are present in the fermentation media. It is generally contemplated that the methods of the invention be used to decrease the content of seed derived tannins relative to that of skin derived tannins. Nevertheless, those of ordinary skill would recognize that the methods by which seeds are separated from skins prior to fermentation of grape juice would also allow one to increase the content of seed derived tannins relative to skin derived tannins in a wine.

While the methods of the invention are primarily directed to the production of improved red wines they may also be used to produce improvements in varieties of white wines which are fermented in the presence of skins and seeds.

While grape skins contain tannins, the nature and composition of these tannins differs from that of seed derived tannins and provide different beneficial characters to the resulting wine. Thus, wines resulting from the methods of the invention therefore differ from those fermented in the presence of grape seeds. Of course, where desired, selected quantities of grape seeds can be restored to the fermenting must in order to further modify the organoleptic character of the resulting wine. Moreover, wine fermented in the presence of grape seeds can be blended with wine fermented in the absence of grape seeds.

### BRIEF DESCRIPTION OF THE FIGURES

FIGS. 1a and 1b depict a cross-section of a seed/skin separating device according to the invention;

FIG. 2 depicts a perspective view of a commercial-size seed/skin separation device of the invention;

FIG. 3 depicts a side elevation view of a skin/seed separation device according to the invention;

FIG. 4 depicts a perspective view of a blade housing according to the invention;

FIG. 5 depicts a continuous grape berry opening device according to the invention;

FIG. 6 depicts a side elevation view of a skin/seed separation device having an undulating plate according to the invention;

FIG. 7 depicts a perspective view of the skin/seed separation device having an undulating plate;

FIG. 8 depicts a side elevation view of a skin/seed separation device comprising a mixer and a scraper device; and

FIG. 9 depicts a side elevation view of a number of mixer and scraper devices in series.

### DETAILED DESCRIPTION

The invention provides an apparatus and methods for inexpensively and efficiently separating the seeds from the skins and pulp of wine grapes. According to one embodiment of the invention, and after initial steps of de-stemming and crushing, funnels deposit the seeds, skins, pulp and grape juice onto an apertured plate having round holes approximately ¼ inch in diameter distributed throughout the plate. While it is contemplated that some grapes might be intact and can be treated on the apertured plates to break them open so as to make the seeds more accessible it is preferred that all or most of the grapes applied to the plates be broken open prior to their application to the plate. As the grape must is deposited on the plate, an inclined grape driving blade drives the grapes along the plate. According to one preferred embodiment of the invention, multiple apertured plates are disposed in a circular arrangement and the blade is a plastic blade having a grape contacting face extending radially out from the center of the arrangement of plates.

As the blade pushes the mixture of grape seeds, skins, pulp and juice across the perforated plate, force is applied both parallel to the plane of the plate and in a direction normal to the plate such that the grape must components are subjected to a shearing action by the flat surface of the plate and further by the edges of the apertures. The normal applied force causes the grape seeds to be capable of being detained by and passing through the plate apertures to the second side of the plate where they may be collected and separated from the juice also passing through the plate apertures.

According to one aspect of the invention, it has been found that apertures having sharp edges such as produced on the distal side of a plate subjected to perforation by mechanical means such as by a punch press or water impingement are preferably oriented toward the wine must to be processed. Such sharp edges appear to increase the shearing force separating the grape must components and may function to “catch” separated grape seeds in a manner that allows them to pass through the plate apertures. In contrast, smooth more rounded edges such as are found on the proximal side of a mechanically punched perforated metal plate tend to decrease the level of shear applied to the grape components and may cause seeds on the verge of passing through a perforation to slip back to the first side of the plate and not pass through the aperture. While it is further contemplated that additional means such as suction means may also be applied to the second side of the plate to induce grape seeds to pass through such additional means may not be necessary and may be undesirable because of the tendency to suck grape skin through the apertures.

While the seeds and juice pass through the plate apertures, the majority of grape skins, pulp and other solids do not pass through the apertures but instead are retained by the plate and are pushed by the driving blade to a trough at the end of the apertured plate. The size and percent open area of the apertured plate along with the speed of the blade determine the quantity of grape must deposited on the plate. Optimally, the amount of grape must deposited on the plate is such for a given plate size and blade speed that all of the seeds have been passed through the plate apertures immediately prior to the remaining solids being pushed to a trough.

According to one aspect of the invention, the seeds and grape juice that are passed through the plate apertures are themselves separated such as by a sieve, flotation, centrifugation or other means and a fraction of the juice is then recombined with the grape skins and pulp and subjected to conventional fermentation steps. The isolated grape seeds may be disposed of or subjected to further processing such as to isolate tannins and other components therein for various uses such as for commercially available dietary supplements (e.g., grape seed extract). This represents a significant improvement over current methods wherein spent grape fermentation mass is dried and shaken or otherwise processed to separate seeds from dried skins and pulp. In addition, the separated grape seeds contain higher levels of available tannins because such tannins were not extracted during fermentation and the seeds were not dried.

The apertured plates used according to the invention are preferably fabricated from stainless steel but may be produced from other metals and materials known to those of skill in the fabrication of food processing equipment. While the apertured plates of the invention can be subjected to coating with various synthetic materials a conventional uncoated stainless steel surface is preferred. The apertured plates are shaped and sized in a manner determined by the overall design of the apparatus which is influenced by the desired capacity of the apparatus, the pattern in which grape must is applied to the plate, how the blade is driven across the plate and how the grape skin and pulp is to be removed from the plate. While a generally rectangular design is preferred so that the grape must may be evenly applied and the blade may evenly push the grape skins, seeds, juice and pulp across the plate treating the grape material in an equivalent fashion at each point along the blade, it is recognized that there are also advantages to mounting one or more blades in a radial configuration and providing multiple apertured plates in essentially trapezoidal arc segments around a common axis. In this fashion six, or eight or ten or more apertured trapezoidal plates may be arranged around a common axis with means for depositing grapes or grape must at the “leading” end of each plate (as defined by where the traveling blade first makes contact with that plate) and a trough for collecting the separated grape skins and pulp at the “trailing” end of each plate. Thus, according to this embodiment multiple blades are disposed outwardly from a central axis which rotates driving each blade across an apertured plate upon which grapes have been deposited. Those of ordinary skill will appreciate, of course, that the method of the invention depends upon the relative motion between blade and plate and thus that while the apertured plates can be stationery and blades in motion in one embodiment that there exists an alternative embodiment in which the blade is stationery and the apertured plate is in motion which can also be practiced.

The apertures in the plates can most conveniently be of the same size and shape but need not be. The apertures are preferably round and may be oval in shape but are most preferably circular with square, rectangular or other polygonal shapes having corners being undesirable because of the tendency of the corners to catch solids or alternatively to fracture or split seeds leading to release of undesirable tannins into the juice. The apertures may be formed by conventional methods but as noted above preferably have sharp edges, as distinguished from rounded edges on the side onto which the grape must is applied. When circular, the apertures themselves preferably have a diameter less than % of an inch with a diameter of about ¼ inch being particularly preferred.

The apertures may be spaced or oriented in any of a variety of manners and a regular spacing and patterning of apertures will function well in practice of the invention. As a consequence, commercially available apertured plates may be readily used in practice of the invention. The apertured plates preferentially have an open area of about 40% but plates with greater or lesser levels of open area may be used in the practice of the invention. It is contemplated that more complex patterns of apertures may be used to optimize the practice of the inventive method and the performance of the apparatus in separating seeds from pulp and skin. Thus, a greater or lesser density of apertures can be disposed toward the region of the plate at which the grape must is deposited with a different density of apertures disposed away from the location at which the grape must is deposited but where the amount of juice (and seeds) remaining in the must is less. Similarly, different patterns of apertures may be found to provide certain advantages as the character of the grape must changes over distance across the apertured plate with the separation of the seeds and juice from retained skins and pulp.

The blade used to push the grape must across the apertured plate may be fashioned from wood, metal or plastic but is preferably plastic. While metal blades can be coated with a silicone rubber or other elastomeric material a plastic blade such as formed from nylon appears to provide the best results.

The blade functions to push the grapes and grape must across the surface of the apertured plate while also applying pressure to the grape must in a direction normal to the surface of the plate to assist in juice and seeds passing through the plate. The blade can have any of a variety of configurations designed to accomplish these goals including flat, convex and concave configurations across its height, and straight and curved configurations across its length. According to one preferred aspect of the invention the blade is straight along its length, has a flat surface along its vertical dimension. The blade is preferably disposed at an acute angle in the direction of movement against the apertured plate with an angle of from 30° to 45° from the plane of the apertured plate being preferred. In this manner, the grape material tends to collect between the blade and the surface of the apertured plate and force is applied both in the direction of movement across the plate but also downward normal to the plane of the plate and through the apertures of the apertured plate. The blade itself may be of any height, provided its edge is propelled flush against the surface of the apertured plate with a clearance less than the diameter of a grape seed such that seeds and other solids are not able to pass between the plate and the blade as it is driven across the plate.

The blade travels across the apertured plate at a speed generally ranging from 0.5 to 20 feet per second although greater and lesser speeds can be practiced by variation of other aspects of the method and device. According to one preferred embodiment, the tip speed of the blade traveling in circular motion across an apertured plate travels blade travels with a speed of about 15 feet per second.

Various means such as funnels, chutes and the like may be used to deliver the grape must to be treated to the apertured plate for separation of seeds from skin. Nevertheless, for optimum results, it is desired that the must be evenly distributed in a thin layer. Specifically, the initial seed/skin layer deposited on the apertured plate should be sufficiently thin, (approximately ¼″ thick), that the seeds readily catch in the holes on the apertured plate and pass through to the second side.

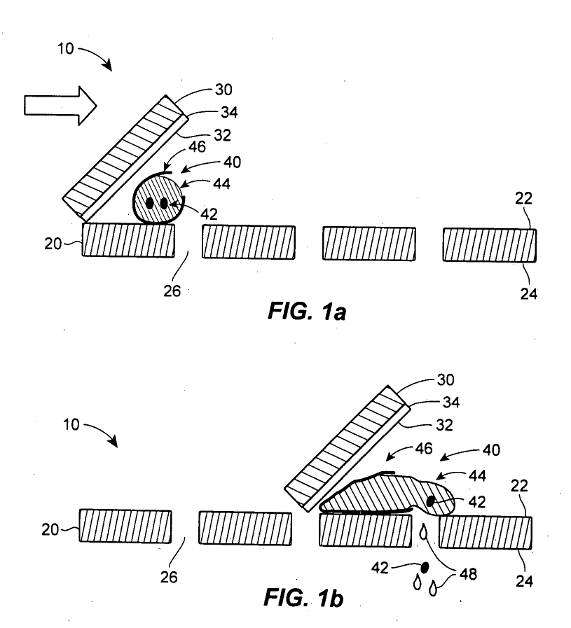

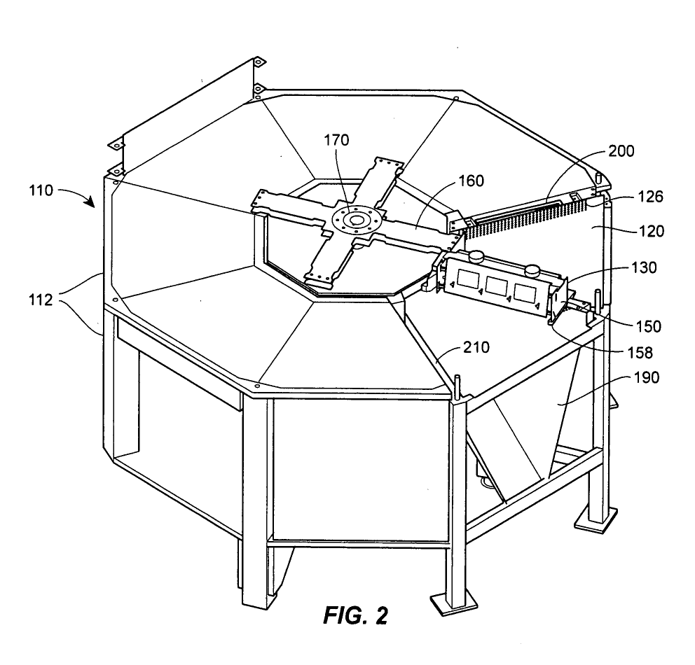

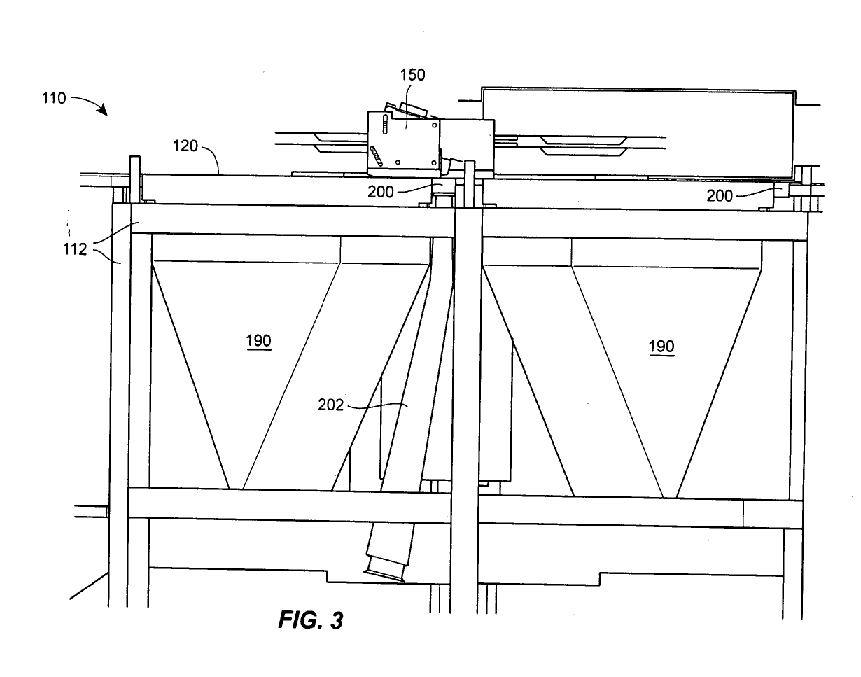

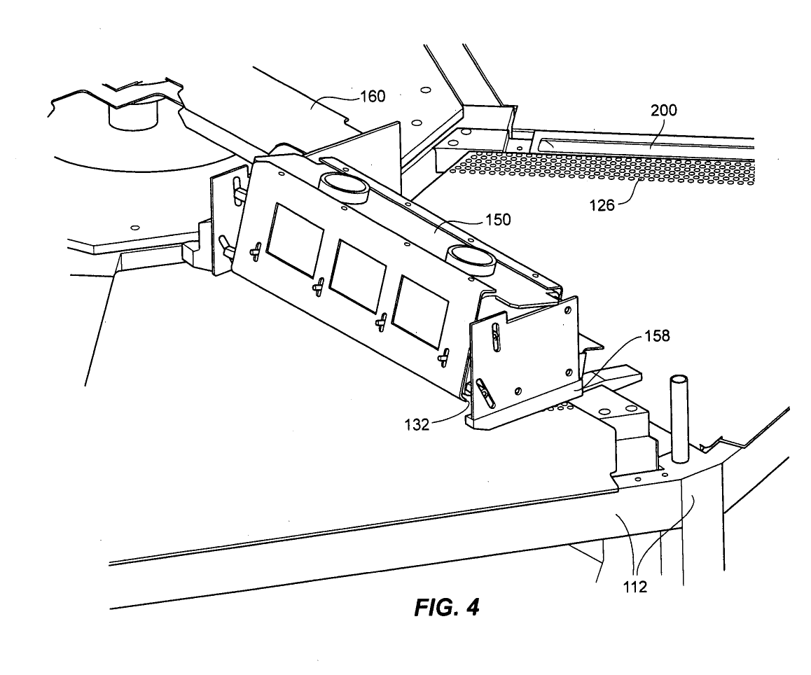

FIG. 2 depicts a perspective view of a commercial-size device 110 of the invention utilizing the apertured plate and blade of FIG. 1. FIG. 3 depicts a side plan view of the same device. FIG. 4 depicts a perspective view of the blade housing 150. The device 110 comprises multiple structural support means 112 supporting a multiplicity of plates 120 having apertures 126 there-through onto which grapes may be deposited for processing. The device also includes one or more blades 130 (each having a grape contacting face 132) and blade housings 150 (only one of which is depicted) wherein the blade 130 is disposed adjacent the surface of the plate 120. The blade housing 150 is supported at its end near the outer periphery of the by means of a skid or roller 158 which contacts the plate surface 120 or optionally a track 128 (not shown) affixed on top of or to the side of said plates 120. At its other end, the blade housing 150 is affixed to a rotor arm 160 which is attached to a drive shaft 170 which drives the blade housing 150 around the plates 120.

The device 110 also comprises a chute 190 disposed underneath each plate 120 for the collection of seeds and juice passing through the plate apertures. Seeds and juice collected in the chutes 190 may then be subjected to separation such as by a sieve (not shown).

The device also has a trough 210 disposed at the trailing edge of plate 120 and prior to the next outlet 200 of the horn shaped feed pipe 202. In operation, crushed grapes are deposited through outlet 200 onto a leading portion of each plate 120 prior to contacting that plate 120 with a blade 130.

The blade 130 is driven onto the leading portion of the plate 120 such that the grape must on the plate is subjected to shearing forces and is driven before the grape contacting face of the blade 132. Grape juice and seeds pass through the apertures 126 to the juice collecting chute 190 while the blade 130 continues to drive grape pulp and skin across the surface of the plate to trough 210. The amount of grape must deposited on each plate is determined by the size of the plate, aperture size, percent open area of the plate and the speed of the blade such that substantially all of the seeds are extracted from the grape pulp and passed through the apertures prior to the point at which the blade 130 reaches the trough 210 located at the trailing portion of each plate 120. It is then intended that this occur in a continuous fashion.

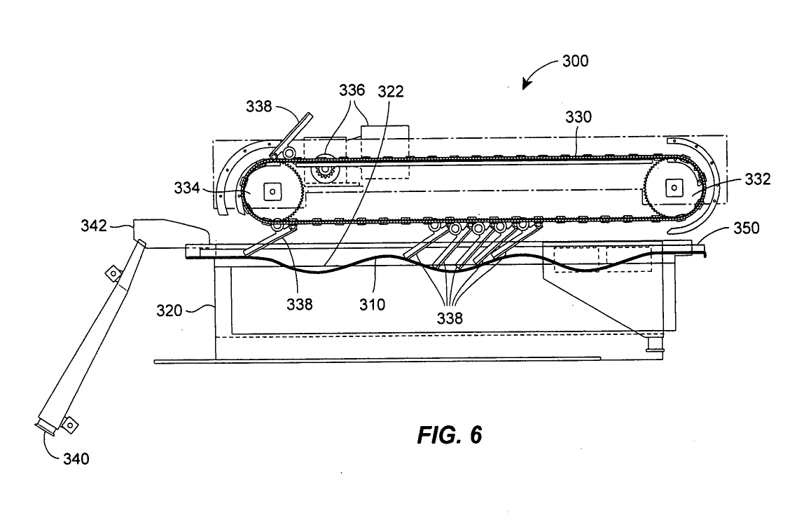

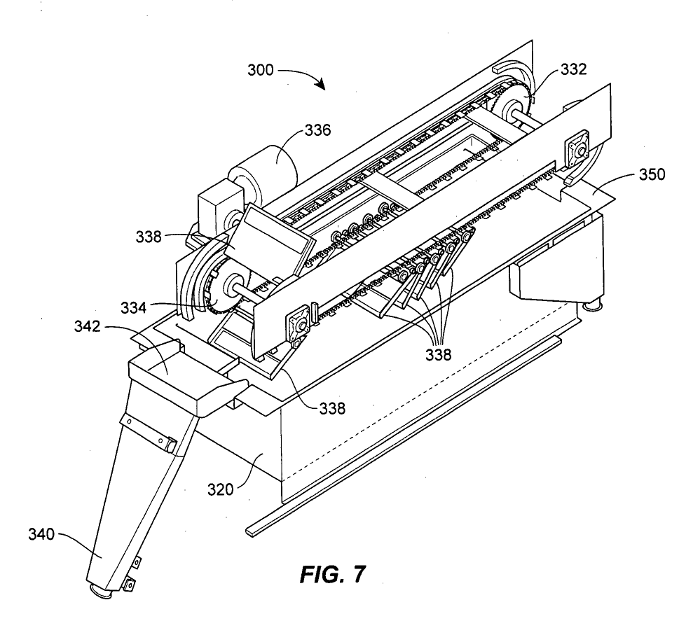

A preferred embodiment for continuous separation of grape seeds from skins in grape must is depicted in FIGS. 6 and 7. The unit 300 comprises a fixed apertured metal plate 310.

The undulating apertured metal plate structure 310 is placed inside a tank 320, with weirs (not shown) along the long sides of the tank. Thus, by filling the tank with juice 322 up to a defined weir height, it is possible to fill the troughs of the undulating apertured metal plate with liquid while leaving the peaks of the apertured plate above the surface of the liquid.

Placed above the undulating apertured metal plate 310 is a continuous chain 330 mounted on two sprocket pulleys 332 and 334 and driven by a variable speed motor 336. Grape driving blades 338 (not all of which are depicted) are mounted to the chain at regular intervals. A feeding horn shaped pipe 340 feeds and distributes grape must comprising skins, seeds, pulp and juice onto a solid metal plate 342 which is in turn attached to the undulating apertured metal plate structure 310.

Grape must comprising a slurry of skin, seeds, pulp and juice is fed continuously through the feeder horn 340 onto the solid metal plate 342 forming an approximately ¼″ thick layer of skins and seeds. This layer is driven across the solid metal plate by the grape driving blade moved toward the undulating apertured metal structure 310.

The grape must driving blades 338 are driven across the solid metal plate 342 at the first end of the apparatus 300 by the chains driven by variable speed motor 336 and function to chop the incoming grape must mixture into 2 inch wide aliquots of grape must. These 2″ wide aliquots are then driven by the blades 338 across the undulating apertured plate 310, alternatively moving down and up along the plate. As the skin/seed mixture moves below the surface of the grape juice 322 it is contacted with the juice which served to separate the skin/seed mixture and permit easier subsequent separation of the seeds from the skins. In this manner each aliquot of grape must simulates the batch results described in Example 7.

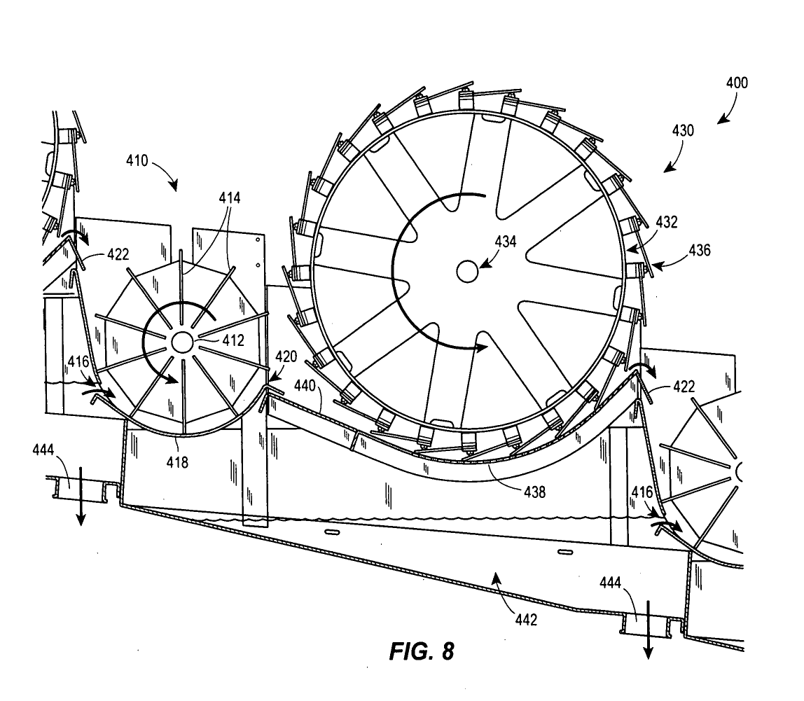

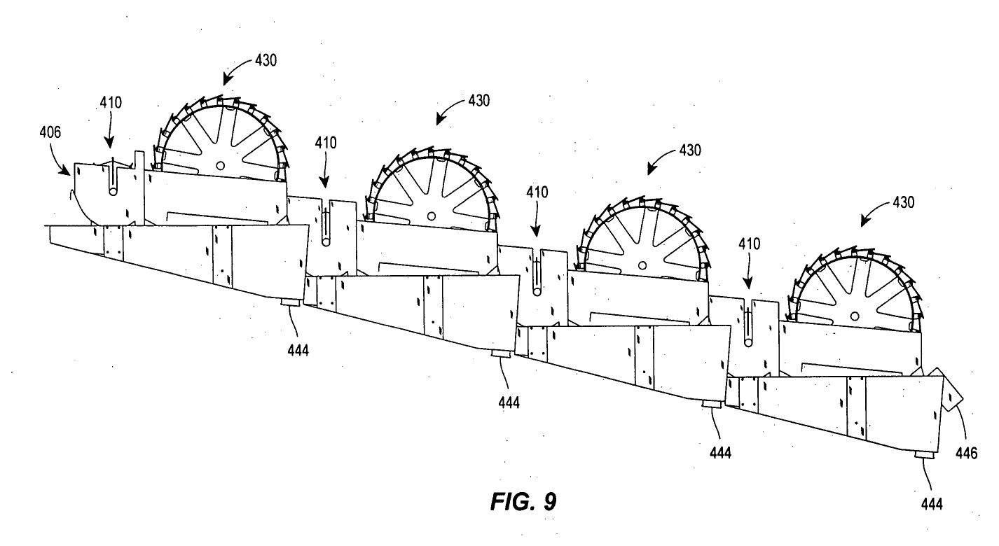

Throughput is controlled by both the speed of the driving blades 338 moving across the undulating apertured plate 310, the width of the apertured plate and the thickness of the must layer placed upon the apertured plate. Conversely, seed separation efficiency is influenced by the height of the grape must layer being continually fed into the equipment and thicker layers have a detrimental effect on separation efficiency. Thus, for example, in order to process 1 ton per minute of grapes, the fixed undulating plate would have to be approximately 7.5 ft. wide, if the feed layer was about ¼ inch thick and the driving blades 338 were moving at a velocity of about 1 ft. per second. A particularly preferred embodiment for continuous separation of grape seeds from skins in grape must is depicted in FIGS. 8 and 9. The mixing/separating unit 400 comprises the combination of a rotary mixer 410 and a scraper drum assembly 430. According to one embodiment the rotary mixer 410 has a diameter of about 15 inches and receives grape must comprising a slurry of grape seeds, skin, pulp and juice from a must inlet 406 (FIG. 9) or from the exit slot 422 of an upstream scraper drum (FIG. 8). The rotary mixer 410 comprises a central axis 412 from which a multiplicity of mixing blades 414 are radially projected. Grape juice or other transporting fluid is introduced to the rotary mixer 410 through an entrance beach 416 defined by a selected weir height. The grape must is combined with and wetted by the grape juice at the bottom portion 418 of the rotary mixer which defines an arc and which contains the grape must and juice. The mixing blades 414 which conform to the arc defined by the bottom portion 418 of the rotary mixer then propel and mix the blend of grape must and transporting fluid (preferably juice) across the bottom portion 418 to an outlet 420 which feeds to the scraper drum assembly 430.

The scraper drum assembly 430 comprises a cylindrical drum 432 rotating on a central axis 434 and has a plurality of driver blades 436. The driver blades 436 engage apertured plate 438 which is preferably defined by having a curved surface defined by having the same axis as the drum 432 but a larger radius. According to one embodiment, the arc defined by the curved surface has a diameter of about 30 inches. The driver blades 436 may be disposed radially from the central axis 434 but are most preferably disposed in a manner such that they form an acute angle in the direction of rotational motion when disposed against the apertured plate 438. Preferably, the blades are disposed such that the angle is from 30° to 45° from the plane of the apertured plate at the point of contact.

Wetted grape must is introduced to the scraper drum assembly 430 from outlet 420 of the rotary mixer 410 and falls by gravity along a plate 440 which preferably is both flat and unperforated. The juice and must composition is then engaged by the driver blades 436 on the apertured plate 438. The resulting layer of grape must is preferably about ¼ inch or less thick and is driven across the apertured plate 438 by the driver blades 436. The seeds and grape juice are driven through the apertures and fall into a tank 442. The partially dried and deseeded grape must containing skins, pulp and seeds is then driven out the exit slot 422 of the separator device which feeds to the next rotary mixer 410 or to a collection trough 446 (FIG. 9).

Juice and seeds are removed from the tank 442 through a drain 444 but a selected amount of juice also flows through the entrance beach 416 into the next rotary mixer 410 in the series. Finally, in the last scrapper drum assembly of the series no juice is provided to a next rotary mixer and the juice and seeds are removed through the drain 444. Some fraction of the juice removed through drains 444 is normally recycled into a continuous pretreatment device together with fresh destemmed grapes. The grape must/juice mixture exiting the device is then fed into the seed separator (406).

Throughput is controlled by both the speed of the driver blades 436 moving across the apertured plate 438, the width of the apertured plate and the thickness of the must layer placed upon the apertured plate. Conversely, seed separation efficiency is influenced by the height of the grape must layer being continually fed into the equipment and thicker layers have a detrimental effect on separation efficiency.

According to one aspect of the invention, a number of mixers and scrapers can be used in series to maximize the efficiency of separation and the throughput of the system. FIG. 9 depicts a series of four mixer/scrapper assembly pairs 400. Greater or fewer mixer/scrapper assembly pairs can be used depending upon the identity and nature of the grapes being processed, the degree of seed separation sought and other factors as would be determined by those practicing the invention. The use of a series of mixers and scrappers improves both the efficiency and throughput of the skin/seed separation process.

In a preferred embodiment of the invention, destemmed/crushed grapes are mixed with recycled grape juice and fed through a continuous pretreatment device (see Example 5) in order to open the berries and expose all the seeds. This slurry is then fed and into the separating device where the seeds are separated from skins.

### EXAMPLE 1

According to this example, a device according to the invention is used to separate seeds from skins in grape must. FIGS. 1a and 1b depict a schematic representation of the device 10 of the invention. Device 10 comprises a plate 20 having a first side 22 and a second side 24 having a plurality of apertures 26 there through having sizes through which grape seeds and juice are capable of passing. The device further comprises a blade 30 having a grape contacting face 32 which can have an elastomeric coating 34. According to one version of its operation, intact and/or crushed grapes 40 comprising one or more seeds 42, pulp 44 and skin 46 are deposited on the first side 22 of the plate and are contacted by the grape contacting face 32 of blade 30 which is disposed adjacent the plate 20 and is driven parallel to the plane of the plate 20. The blade face 32 is disposed in a manner, in this case by forming an acute angle with the plane of the plate 20, such that as it is driven across the plate 20 one or more grapes 40 are wedged between the blade 30 and the plate 20 and force is applied to the grapes 40 both in a direction parallel with the plane of the plate 20 but also downward normal to the plate 20.

The grapes 40 comprise one or more seeds 42, pulp 44 surrounding the seeds and skin 46 and may be previously crushed or can be intact. As depicted in FIG. 1b movement of the blade 30 separates the contents of a grape 40 and a shearing action occurs between the seed 42, pulp 44 and skin 46 components of the grape 40 and the first side 42 of the plate as a consequence of the movement of the grape material across the plate 20. This shearing action functions to separate the seeds 42 from the skin 46 and other grape components and the seeds 42 and juice 48 produced by crushing of the pulp 44 pass through one or more apertures 26. The grape pulp 44 and skin 46 are retained on the first side of the plate 22 and may be collected at a point at which substantially all the seeds 42 have been removed. The seeds 42 and juice 48 which passed through the apertures 26 to the second side of the plate 24 may then be separated by conventional filtration means (not shown) and the separated juice 48 recombined with the isolated grape pulp 44 and skin 46 before being subjected to further treatment and fermentation.

According to another method of using the device of FIG. 1 grape must made from crushed grapes comprising seeds, skin, pulp and juice is poured into the face of apertured metal plate 20 comprising ¼ inch diameter holes with about 40% open area. The juice pours through the holes and the seeds and skins are retained on the apertured plate. A flat thin metal sheet 30 is then placed at an angle of approximately 30° to the apertured plate 20 and moved over the seed/skin mixture applying both horizontal and downward vertical force components to the seed/skin mixture. The seeds catch in the ¼ inch perforations and separate from the skins. This is repeated 3 to 4 times resulting in very efficient seed/skin separation.

### COMPARATIVE EXAMPLE 2

It has been observed that the seed/skin separating devices of the invention are better able to separate the seeds from skin of grape berries which have already been opened (i.e., had their skin ruptured). This is due to the tendency of intact grape berries to roll in front of the grape driving blade and not become caught by the edges of the apertures. As discussed above, conventional destemmer/crushers frequently open fewer than 50% of the grape berries that they process. The efficiency of grape crushing is dependant on grape size and variety, e.g., Merlot grapes tend to have a significant amount of pulp surrounding seeds, so that even when crushed, the seeds are not completely exposed for separation. Accordingly, it is sometimes desired to pre-treat the grape berries in the grape must to open the grape berry to better expose the seeds within the mucilage of the grape pulp.

According to this example illustrating conventional grape crushing methods, 30 lbs chardonnay grapes were passed through an industrial grape destemmer, roller crusher (with the rollers set at their closest separation) and 28.5 lb of crushed grapes and juice were collected (1.5 lb stems). The crushed grapes and juice were separated using a screen into 16 lb of grapes, skins, seeds and 12.5 lb juice. These results suggest that only 56% of the grapes were crushed such that their seeds were exposed.

### COMPARATIVE EXAMPLE 3

According to this example illustrating the limitations of conventional grape crushing methods, the method of Comparative Example 2 was repeated with 41.5 lbs of Merlot grapes passed through an industrial grape destemmer/roller crusher with the rollers set at their closest separation. 6 lb of juice and 23.5 lb of grapes, skins and juice were collected suggesting that only 25% of the grape berries were opened.

The crushed mash was then passed through the destemmer/crusher a second time, and now 8.5 lb juice and 20 lb of grapes, skins and seeds were collected; with the juice now still only representing 30% of the crushed must suggesting that only 38% of the seeds were exposed. However, even the observable seeds were still surrounded by a significant amount of attached mucilage (Merlot grapes are characterized by high levels of pulp.)

These experiments show that conventional destemming/crushing methods do not function to open a majority of grape berries. According to one aspect of the invention, a pretreatment step is carried out by which substantially all of the grape berries are broken open so that the grape seeds may then be separated from the skins and pulp. After this, the pretreated seed/skin/juice mixture may be treated to separate the skins from seeds by treatment across an apertured plate.

### EXAMPLE 4

According to this example, a method of pretreating grape berries to open the fruit and better expose and separate the mucilage from the seeds was carried out in accordance with this invention. These exposed seeds could then be easily and very efficiently separated from the skins. Specifically, 520 grams of hand destemmed Merlot grape berries were crushed in a small laboratory crusher, producing 302 grams of seeds/skins/mucilage and 218 grams juice. A 200 gram quantity of the seed/skin/mucilage was mixed with 218 grams of grape juice and with 300 ml of 20% sugar solution to produce a thinner slurry mix.

After mixing for 10 seconds with a small electric mixer, the slurry was placed in a laboratory Waring blender and the blender knives were run at 10,000 rpm for 15 seconds. Due to vortexing during the blending some foam was produced and the entire contents of the blender were then placed into a funnel with the exit neck closed, in order to allow the entrained air to separate. After about 1½ minutes the top floating skins and seeds were skimmed off and placed onto a fine screen. 93 grams of skins containing 13 seeds were collected on the fine screen.

The remaining skins, seeds and juice from the funnel were then poured onto an apertured metal plate leaving ¼ inch diameter holes. The juice and some seeds flowed through the one apertured metal plate, while the majority of skins and seeds were retained on the apertured metal plate.

A second metal plate with its edge (grape driving blade) was placed at an angle of 30° to the apertured plate and was then driven by hand across the plate. Some seeds passed through to the second side of the plate while the remainder of the skin/seed mixture was retained on the surface of the apertured metal plate. During this action, seeds were caught in the apertured metal holes and separated from the skins which were retained on top of the apertured metal plate. Movement of the second metal plate across the apertured plate was repeated several times with the result that 384 seeds passed through to the second side of the apertured metal plate and 12 grams of skins were retained on the first side of the apertured plate containing no seeds. This experiment showed a 97% seed separation from the skins!

### EXAMPLE 5

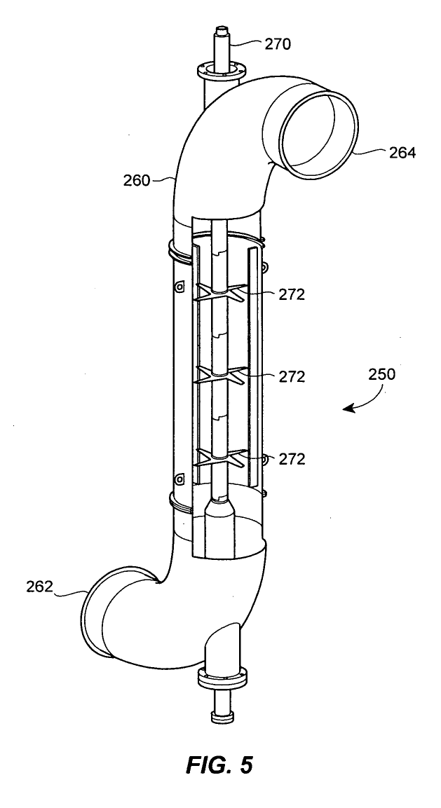

While the preceding examples demonstrated the utility of the batch-style grape berry pretreatment and seed/skin separation methodologies, there remains a need for continuous processes for grape pretreatment to open the berries as well as for continuous processes for seed/skin separation. According to this example, an apparatus 250 is depicted in FIG. 5 by which grape berries can be opened in a continuous mode was constructed comprising a tube 260 twelve inches long and four inches in diameter having an inlet 262 and an outlet 264. The tube has a shaft 270 running along the center of its axis on which are three, four-bladed knives 272 mounted for axial rotation. The shaft was connected to a variable speed motor (not shown) whose speed could vary from 2000 to 6000 RPM.

Ninety pounds of grapes were destemmed and crushed in an industrial destemmer/crusher and then mixed with 90 pounds of 25% sugar solution (to simulate the juice recycle stream needed for slurry dilution.) This diluted slurry was then introduced at inlet 262 of the apparatus and pumped through the 4-inch container at a rate of 145 lb./minute while the central shaft was rotating at approximately 4000 RPM. When operated in a continuous manner, a portion of the juice present in the slurry exiting the outlet 264 can be separated and recycled to combine with the grape must.

As noted earlier, the incoming grape must slurry introduced to the device at inlet 262 had a substantial fraction of the grape berries still intact. However, essentially all seeds were exposed in the outlet stream from the flow-through continuous “blender” pretreatment apparatus and the resulting product was substantially free of fractured seeds (there were no observable fractured seeds).

### EXAMPLE 6

In the seed/skin separation examples above, it was observed that the grape juice portion of the grape must tends to quickly flow through the perforations in the apertured plate leaving a relatively drier mixture of seeds, skin and pulp to be processed for separation. This effect becomes even more pronounced when the grape berries are treated to open a higher percentage of the berries than are typically opened simply by conventional destemming and crushing. Not only does the removal of the grape juice leave the skins and seeds to be separated under relatively drier conditions but the seeds, skins and pulp tend to adhere to one another because grape juice is essentially an approximately 20-25 Brix sugar solution. This stickiness makes separation between the seeds and skins more difficult to achieve.

According to this example, grape seeds and skins are separated by a technique designed to address the issue of dry sticky grape must. Manually de-stemmed red grapes were crushed in a highly efficient small laboratory crusher, such that essentially all the seeds were exposed but mixed with skins, so that further “pretreatment” was unnecessary.

Accordingly, 56 grams of grape must containing pulp, skins and seeds was placed on the first end of a apertured metal plate 12 inches in length with an effective width of about 6 inches, having ¼ inch apertures with 40% open area. These 56 grams of skins and seeds represented a layer approximately 6″ wide by 2″ long by ¼″ high. The plate was then lowered into a plastic container partially filled with 20-25 Brix sugar solution and submerged at a 10-15° angle to the horizontal such that the end holding the grape must was submerged and roughly two-thirds of the plate was submerged below the surface of the sugar solution.

The 56 gram layer of grape must was then driven along the apertured plate in the upward direction by a flat plate maintained at an angle of approximately 30° from the surface of the apertured plate. The first two-thirds of the driving process occurs with the skins and seeds underneath the level of the sugar solution wetting the seeds and the skins, so that the final third of the process which was carried out above the level of the sugar solution, could easily separate the seeds from the skins. The skins and seeds reaching the second end of the plate were then collected and saved.

This process was repeated with several additional 56 gram quantities of grape must comprising skins and seeds and each time the skins and seeds reaching the second end of the plate after a single pass of the driving blade were collected and saved. An analysis of the number of seeds remaining on the first side of the plate counted 307 seeds which remained with the skins while 316 seeds were counted in the sugar solution below the apertured plate. Thus, approximately 50% of seeds are separated from a single pass of the blade on a ¼″ high layer of seeds and skins.

The experiment was then repeated with 56 gram quantities of grape must comprising skins and seeds but with three passes across the plate carried out on each 56 gram quantity of grape must. Specifically, a first “pass” was carried out in the direction from the first end of the plate under the surface of the sugar water to the second end of the plate above the liquid surface, and then a second pass was carried out wherein the blade drove the grape must from the second end to the first end back underneath the level of the sugar solution. Finally, a third and final pass was carried out with the blade driving the grape must from the first end of the plate below the liquid surface to the second end of the plate above the liquid surface.

During the movement of the driving blade from one end of the apertured plate to the other, the initial ¼ inches thick by 6 inches wide by 2 inches long layer of skins and seeds gets rolled up into a cylindrical roll approximately 0.8 inches in diameter by 6 inches wide.

In driving the grape must from the second end of the plate to the first, the cylindrical roll was then pushed back into the sugar solution, which acted to separate the skins and seeds back into a thinner layer. Some seed separation occurs during the movement from the second end to the first but much more separation was then possible from the thinner layer in the final movement from the first end to the second. Thus by alternately driving the grape must above and below the level of grape juice (sugar solution), the juice caused the thin skin/seed layer to be reformed multiple times.

The three-pass process was repeated with several additional 56 gram quantities of grape must and the numbers of seeds which had passed through the apertured plate and the number which had remained on the first side of the plate were counted. In this case 82% of the seeds were separated from the skins and were present in the solution below the apertured plate. This compares favorably with the 50% of seeds separated by the single pass method.

Finally, the experiment was repeated again but with a 112 gram quantity of grape must which produced a layer approximately ½″ thick. The three-pass process was repeated but only 66% of seeds were found to pass through the apertured plate indicating that a thinner layer produced superior results.

### EXAMPLE 7

According to this example, the device 300 for continuous separation of grape seeds from skins in grape must depicted in FIGS. 6 and 7 was combined with a continuous pretreatment device as depicted in FIG. 5.

According to one experiment, 210 lbs of grapes were crushed on an industrial destemmer/crusher. These partially crushed grapes were then mixed with an equal weight of 25% sugar solution (to simulate grape juice) and pumped through the continuous high speed blender pretreatment device of Example 5 in order to open the berries and expose all the seeds. This slurry was then fed into the continuous separator device 300 at a rate equivalent to about 90 lb/min of grapes.

The juice entering with the grape must including skins and seeds was continuously separated form the skins and seeds, and flowed through the apertured metal plate 310, pouring over the weirs and thus maintaining a defined liquid level in the troughs of the undulating apertured metal screen. Seeds were separated from the skins by the action of the driving blade 338 as the skin/seed mixture moved across the apertured plate and the seeds were collected in the tank 320 below the undulating apertured metal plate 310. The skin and pulp were then driven by the blades 338 onto a flat non-apertured plate 350 from which they can be collected.

After the entire 210 lbs of grape must had passed through the pretreatment process and the separator the feed was stopped and the contents of the tank 320 drained. Approximately 8 lbs of seeds were recovered from the tank. Previous measurements has shown that the seeds of the particular grape variety test represented 4.5% of the berry weight. Thus the 8 lbs of seeds separated from the slurry represented a separation efficiency of approximately 85%.

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed is:

1. A method of opening grape berries comprising:
combining grape berries and a transporting fluid in an apparatus comprising a container and a means for generating shear; and
applying a shear force sufficient to break open the skin of grape berries within said container to produce a mass comprising grape pulp, seeds and skin wherein greater than 70% of said berries are opened.

2. The method of claim 1 wherein greater than 80% of said berries are opened.

3. The method of claim 1 wherein greater than 90% of said berries are opened.

4. The method of claim 1 wherein greater than 95% of said berries are opened.

5. The method of claim 1 wherein fewer than 5% of said seeds are fractured.

6. The method of claim 1 wherein fewer than 2% of said seeds are fractured.

7. The method of claim 1 wherein fewer than 1% of said seeds are fractured.

8. The method of claim 1 wherein the means for generating shear is a blade mounted for axial rotation within the container.

9. The method of claim 8, wherein the blade comprises at least two arms which extend radially outwardly from the blade's axis of rotation.

10. The method of claim 8 wherein the device comprises more than one set of blades.

11. The method of claim 8 wherein grape berries and transporting fluid are introduced to and grape pulp, seeds and skin are removed from the apparatus on a continuous basis.

12. The method of claim 8 wherein the blade rotates at a rate between 1500 rpm and 10,000 rpm.

13. The method of claim 1 wherein the container comprises an elongated tube in which grape berries and transporting fluid are introduced at a first end and grape pulp, seeds and skin are expelled at a second end.

14. The method of claim 12 wherein the blade rotates at a rate between 1500 rpm and 6,000 rpm.

15. The method of claim 1 wherein transporting fluid is grape juice.

16. The method of claim 1 wherein at least some of the transporting fluid is separated from the product mass comprising grape pulp, seeds and skin and is recombined with unopened grape berries being introduced to the apparatus.

17. An apparatus for opening grape berries to produce a mass comprising grape pulp, seeds and skin wherein greater than 70% of said berries are opened comprising:
a container and a means for generating shear sufficient to break open the skin of grape berries within said container which is a blade mounted radially outwardly for axial rotation within the container.

18. The apparatus of claim 17 wherein the device comprises more than one set of blades.

19. The apparatus of claim 17 which is a batch processing device.

20. The apparatus of claim 17 which is a continuous processing device.

21. The apparatus of claim 17 wherein the container comprises an elongated tube into which grape berries may be introduced at a first end and through which grape pulp, seeds and skin are expelled at a second end.

22. The apparatus of claim 17 wherein fewer than 5% of said grape seeds are fractured.

23. The apparatus of claim 17 further comprising means for introducing grape juice which has been separated from grape berries previously opened by the apparatus.

24. Grape must produced according to the method of claim 1.

25. The grape must of claim 24 wherein greater than 80% of said berries are opened.

26. The grape must of claim 24 wherein greater than 90% of said berries are opened.

27. A method for treating grape must to separate grape seeds from grape skins and grape pulp in the grape must comprising:
introducing grape must onto the first side of a plate having first and second sides and apertures there-through of a size and shape selected such that grape seeds, juice and skin can nominally pass through to the second side of the plate;
driving said grapes across said plate by means of a blade having a grape contacting face disposed such that the clearance between the blade and the plate is less than the diameter of a grape seed; the motion and orientation of the blade relative to the plate being such as to apply forces to the grape that are both parallel to and normal to the plane of the plate such that the grape seeds and juice will pass through the apertures to the second side of the plate while retaining grape skin and pulp on the first side of the plate, and
collecting said grape seeds and juice from the second side of the plate and grape skin from the first side of the plate.

28. The method of claim 27 further comprising the step of separating the grape seeds from the grape juice which have passed through to the second side of the apertured plate.

29. The method of claim 27 wherein the grape juice separated from the grape seeds is recombined with the skins retained on the first side of the plate.

30. The method of claim 27 wherein the apertures have a minor dimension greater than 3/16 inch and a major dimension less than ⅜ inch.

31. The method of claim 27 wherein the apertures are round.

32. The method of claim 30 wherein the apertures are circular.

33. The method of claim 27 wherein the blade is disposed such that its grape contacting face forms an acute angle with the plate.

34. The method of claim 27 wherein the grape contacting face of the blade is concave.

35. The method of claim 27 wherein grape skins and pulp which are retained on the first side of the plate are collected in a trough disposed at one end of said plate.

36. The method of claim 27 wherein said plate comprises at least one portion of said plate is immersed in grape juice and at least one other portion of said is not immersed in grape juice.

37. The method of claim 27 in which said plate comprises alternating higher and lower portions relative to the horizontal in the direction of blade movement such that portions of the plate are immersed in grape juice.

38. The method of claim 27 wherein one or more of said blades are disposed from a rotary arm and are driven across one or more of said plates about the axis of the rotary arm.

39. The method of claim 27 wherein said blade is mounted upon a conveyor which drives the blade across one or more plates.

40. The method of claim 27 wherein the plate remains stationary and the blade is moved across the plate.

41. The method of claim 27 wherein the blade remains stationary and the plate is moved across the blade.

42. The method of claim 27 wherein said grapes introduced to the first side of said plate are preprocessed according to the method of claim 1.

43. The method of claim 27 wherein a transporting fluid is mixed with the grape must prior to the separation step.

44. The method of claim 43 wherein the transporting fluid is grape juice.

45. The method of claim 43 wherein the transporting fluid is mixed with the grape must in a rotary mixer having multiple blades projecting from a horizontally disposed axis.

46. An apparatus for separating grape seeds from grape pulp and grape skin in grape must comprising:
a plate having a first side and a second side and apertures there-through with a shape selected such that grape seeds, juice and skin can nominally pass through to the second side of the plate;
means for depositing grape must onto the first side of said plate;
a blade having a grape contacting face disposed adjacent said plate the clearance between the blade and the plate being less than the diameter of a grape seed and the blade being disposed such that when it moves parallel to the plane of the plate it applies forces to the grapes that are both parallel to and normal to the plane of the plate such that the grape seeds and juice will pass through the apertures of the plate while retaining grape skin;
means for driving said blade in a direction parallel to said plate to move grapes across said plate;
means for collecting grape seeds and juice which pass through the apertures of the plate; and
means for collecting grape skins and pulp which are retained on the first side of the plate.

47. The apparatus of claim 46 comprising means for separating grape seeds from said juice which have passed through the apertures of the plate.

48. The apparatus of claim 47 wherein said means for separating grape seeds from juice is a sieve.

49. The apparatus of claim 46 wherein the apertures have a minor dimension greater than 3/16 inch and a major dimension less than ⅜ inch.

50. The apparatus of claim 46 wherein the apertures are round.

51. The apparatus of claim 50 wherein the apertures are circular.

52. The apparatus of claim 46 wherein the blade is disposed such that its grape contacting face forms an acute angle with the plate.

53. The apparatus of claim 46 wherein the grape contacting face of the blade is concave.

54. The apparatus of claim 46 wherein said means for collecting grape skins and pulp which are retained on the first side of the plate is a trough disposed at one end of said plate.

55. The apparatus of claim 46 wherein said plate comprises at least one portion which is immersed in grape juice and at least one other portion which is not immersed in grape juice.

56. The apparatus of claim 46 wherein the plate is flat.

57. The apparatus of claim 46 in which said plate is undulating in the direction of blade movement.

58. The apparatus of claim 57 wherein the undulating plate comprises alternating higher and lower portions relative to the horizontal such that said lower portions of the plate are immersed in a trough containing grape juice.

59. The apparatus of claim 46 wherein one or more of said blades are disposed from a rotary arm and one or more of said plates are disposed about the axis of said rotary arm.

60. The apparatus of claim 46 which comprises a conveyor upon which one or more of blades are mounted and which functions to drive said blades across said plates.

61. The apparatus of claim 46 wherein the plate remains stationary and the blade is moved across the plate.

62. The apparatus of claim 46 wherein the blade remains stationary and the plate is moved across the blade.

63. The apparatus of claim 46 wherein the plate defines a circular arc and the blade is disposed on a cylindrical drum concentric with said circular arc wherein the cylindrical drum rotates so as to move the blade along the apertured plate.

64. A system for separating grape seeds from grape skins comprising at least a first and a second apparatus of claim 63 in series.

65. The system for separating grape seeds from grape skins of claim 64 further comprising a mixing device which recombines at least a portion of the grape juice separated from a first separating apparatus with the grape must exiting from that first apparatus to rewet the grape must before the grape must is introduced to the second apparatus.

66. The system of claim 65 wherein the mixer comprises a trough and at least one blade which serves to propel the wetted must through the trough and into the second separating apparatus.

67. The system of claim 66 wherein the mixer is a rotary mixer having multiple blades projecting from a horizontally disposed axis.

68. A method of producing wine comprising the steps of:
separating the grape juice from the grape seeds according to the method of claim 27;
recombining the separated grape juice with all or a portion of the grape skin separated by the method of claim 27; and
fermenting the recombined grape juice and grape skin to produce wine.

69. Wine produced according to the method of 68.

70. A method of producing wine comprising the steps of:
combining grape berries and a transporting fluid in an apparatus comprising a container and a means for generating shear; and applying a shear force sufficient to break open the skin of grape berries within the container to produce a mass comprising grape pulp, seeds, skin and juice wherein greater than 70% of said berries are opened, and
fermenting the mass to produce wine.

71. The method of claim 70 wherein the shear force which breaks open the grape berries fractures fewer than 5% of said grape seeds.

72. Wine produced according to the method of claim 70.

73. A method for treating grape pomace to separate grape seeds from grape skins and grape pulp in the grape pomace comprising:
introducing grape pomace onto the first side of a plate having first and second sides and apertures there-through of a size and shape selected such that grape seeds, transporting fluid and skin can nominally pass through to the second side of the plate;
driving said grapes across said plate by means of a blade having a grape contacting face disposed such that the clearance between the blade and the plate is less than the diameter of a grape seed; the motion and orientation of the blade relative to the plate being such as to apply forces to the grapes that are both parallel to and normal to the plane of the plate such that the grape seeds and transporting fluid will pass through the apertures to the second side of the plate while retaining grape skin and pulp on the first side of the plate, and
collecting said grape seeds and transporting fluid from the second side of the plate to the grape skin from the first side of the plate.

74. The method of claim 73 wherein the transporting fluid is water.

75. A method of producing wine comprising the steps of
combining grape berries and a transporting fluid in an apparatus comprising a container and a means for generating shear; and applying a shear force sufficient to break open the skin of grape berries within the container to produce a mass comprising grape pulp, seeds, skin and juice wherein greater than 70% of said berries are opened, and
separating the grape juice from the grape seeds in the mass according to a method comprising the steps of: introducing the mass onto the first side of a plate having first and second sides and apertures there-through of a size and shape selected such that grape seeds, juice and skin can nominally pass through to the second side of the plate;
driving said grapes across said plate by means of a blade having a grape contacting face disposed such that the clearance between the blade and the plate is less than the diameter of a grape seed; the motion and orientation of the blade relative to the plate being such as to apply forces to the grape that are both parallel to and normal to the plane of the plate such that the grape seeds and juice will pass through the apertures to the second side of the plate while retaining grape skin and pulp on the first side of the plate, and
collecting said grape seeds and juice from the second side of the plate and grape skin from the first side of the plate;
separating said grape juice from said grape seeds and recombining the separated grape juice with all or a portion of the separated grape skin; and
fermenting the recombined grape juice and grape skin to produce wine.

76. The method of claim 75 wherein the shear force which breaks open the grape berries fractures fewer than 5% of said grape seeds.
